(19) United States
(12) Patent Application Publication
(10) Pub. No.: US 2016/0225181 A1
(43) Pub. Date: Aug. 4, 2016

(54) METHOD AND APPARATUS FOR DISPLAYING MEDICAL IMAGE

(71) Applicant: Samsung Electronics Co., Ltd., Gyeonggi-do (KR)

(72) Inventors: Jun-sung PARK, Seoul (KR); Jun-ki LEE, Gyeonggi-do (KR)

(21) Appl. No.: 14/845,487

(22) Filed: Sep. 4, 2015

(30) Foreign Application Priority Data
Feb. 2, 2015 (KR) 10-2015-0016186

(51) Int. Cl. G06T 15/08; G06T 11/00

(52) U.S. Cl. CPC G06T 15/08; G06T 11/008; G06T 2211/40; G06T 2215/16

(57) ABSTRACT

A method and apparatus for displaying a medical image of an object. A user input is received to select at least one position in a 2D medical image generated from volume data representing the object. A space region in the volume data is determined, which includes the selected position, where the space region is based on brightness of voxels included in the volume data. A 3D medical image is generated and displayed, representing the determined space region by performing volume rendering on the volume data. The space region may be a region of an organ, tissue, tumor, etc., of the overall object, which includes the position selected on the 2D image.

### CLAIM OF PRIORITY

This application claims the benefit under 35 U.S.C. §119 of Korean Patent Application No. 10-2015-0016186, filed on Feb. 2, 2015, in the Korean Intellectual Property Office, the disclosure of which is incorporated herein in its entirety by reference.

### BACKGROUND

1. Field

This disclosure relates generally to medical image display technology and more particularly to generating and displaying a three-dimensional (3D) medical image.

2. Description of the Related Art

A medical imaging system may include a medical image acquiring apparatus for acquiring a medical image and a medical image display apparatus for displaying a medical image.

A medical image acquiring apparatus (imaging apparatus) acquires a medical image about a 2D slice of a subject (object), or blood flow through a subject by using a signal obtained by irradiating a predetermined signal toward the object and receiving a signal reflected from or passing through the object. For example, the imaging apparatus may acquire an ultrasound image, an X-ray image, a computerized tomography (CT) image, a magnetic resonance (MR) image, a positron emission tomography (PET) image, etc.

A medical image display apparatus displays an acquired medical image on a screen. The display apparatus may be an apparatus separated from the imaging apparatus, an apparatus included in the imaging apparatus, or an apparatus connected to the imaging apparatus. The display apparatus may include a console for controlling the imaging apparatus.

The display apparatus may display information related to functions of acquiring a medical image of an object and displaying an acquired medical image. For example, the display apparatus may display various items of information processed in the imaging apparatus or the display apparatus and a user interface for controlling the imaging apparatus or display apparatus.

The display apparatus may display a two-dimensional (2D) medical image showing a section of an object and a 3D medical image showing space information of the object. The 3D medical image may provide information about a space occupied by the object, which has not been provided by the 2D medical image.

When providing a 3D ultrasound image of an object, a general medical image display apparatus displays a 3D medical image generated by rendering the entire volume data acquired with respect to the object. Accordingly, a user of a general medical image display apparatus who views only a 3D medical image of the entire region of the object acquired from the volume data may have difficulty observing in detail a desired portion of the object with sufficient accuracy.

### SUMMARY

Illustrative embodiments provide a method and apparatus for quickly and accurately generating and displaying a three dimensional medical image of a particular portion (e.g., organ, tissue, tumor, etc.) of an object desired by a user. The particular portion may be identified via user selection of a position on a 2D image.

Additional aspects will be set forth in part in the description which follows and, in part, will be apparent from the description, or may be learned by practice of the presented exemplary embodiments.

According to one or more exemplary embodiments, a method for displaying a medical image of an object includes receiving a user input to select at least one position in a 2D medical image generated from volume data representing the object, determining a space region in the volume data including the selected position, based on brightness of voxels included in the volume data, generating a 3D medical image representing the determined space region by performing volume rendering on the volume data, and displaying the 3D medical image.

The receiving of the user input may include displaying the 2D medical image, and receiving a user input to select at least one position in the displayed 2D medical image.

The receiving of the user input may include displaying the 2D medical image, and obtaining coordinate information indicating a location of the at least one position in the volume data, based on the user input to select the at least one position in the displayed 2D medical image.

The determining of the space region in the volume data may include obtaining a brightness value of the selected position, determining brightness values included in a predetermined range determined based on the obtained brightness value, and determining the space region in the volume data including the selected position and formed of voxels having the determined brightness values.

In the determining of the space region in the volume data, the space region in the volume data including the selected position may be determined by using a region growing algorithm.

The determining of the space region in the volume data may include setting an initial region having a predetermined size including the selected position, determining a contour of a tissue of the object included in the set initial region, and determining the space region in the volume data based on the determined contour.

In the determining of the contour, the contour of a tissue of the object included in the set initial region may be determined by using an active contour algorithm.

In the displaying of the 3D medical image, a marker indicating a location of the selected position in the determined space region may be displayed on the 3D medical image.

In the displaying of the 3D medical image, the 3D medical image may be displayed to at least partially overlap the 2D medical image.

According to one or more exemplary embodiments, a medical image display apparatus includes a user input unit configured to receive a user input to select at least one position in a 2D medical image generated from volume data representing the object, a processor configured to determine a space region in the volume data including the selected position, based on brightness of voxels included in the volume data, and generate a 3D medical image representing the determined space region by performing volume rendering on the volume data, and a display configured to display the 3D medical image.

According to one or more exemplary embodiments, a non-transitory computer readable storage medium having stored thereon program instructions, which when executed by a computer, causes a medical image display apparatus to: receive a user input to select at least one position in a 2D medical image generated from volume data representing the object, determine a space region in the volume data including the selected position, based on brightness of voxels included in the volume data, generate a 3D medical image representing the determined space region by performing volume rendering on the volume data, and display the 3D medical image.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a method of generating and displaying a three-dimensional (3D) medical image of a partial region of an object by using a general medical image display apparatus;

FIG. 2 is a block diagram of a medical image display apparatus according to one of various exemplary embodiments;

FIG. 3 is a block diagram of a medical image display apparatus according to one of various exemplary embodiments;

FIG. 4 is a block diagram of a processor included in a medical image display apparatus according to one of various exemplary embodiments;

FIGS. 5 and 6 depict respective screen images of a 3D medical image displayed by a medical image display apparatus according to an exemplary embodiment;

FIGS. 7 and 8 depict respective screen images of a 3D medical image on which a marker indicating a location of a selected position in a two-dimensional medical image is displayed, when a medical image display apparatus according to an exemplary embodiment displays the 3D medical image;

FIG. 9 is a flowchart of a method of displaying a 3D medical image, the method being performed by a medical image display apparatus, according to one of various exemplary embodiments; and

FIG. 10 is a flowchart of a method of determining a space region in volume data including a position selected by a user, the method being performed by a medical image display apparatus, according to one of various exemplary embodiments.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present disclosure.

As used herein, the term “and/or” includes any and all combinations of one or more of the associated listed items. Expressions such as “at least one of,” when preceding a list of elements, modify the entire list of elements and do not modify the individual elements of the list.

Exemplary embodiments are provided to further completely explain the present inventive concept to one of ordinary skill in the art to which the present inventive concept pertains. However, the present inventive concept is not limited thereto and it will be understood that various changes in form and details may be made therein without departing from the spirit and scope of the following claims. That is, descriptions on particular structures or functions may be presented merely for explaining exemplary embodiments of the present inventive concept.

Terms used in the present specification are used for explaining a specific exemplary embodiment, not for limiting the present inventive concept. Thus, the expression of singularity in the present specification includes the expression of plurality unless clearly specified otherwise in context. Also, terms such as “comprise” and/or “comprising” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

In the present specification, when a constituent element “connects” or is “connected” to other constituent element, the constituent element contacts or is connected to the other constituent element not only directly, but also electrically through at least one of other constituent elements interposed therebetween. Also, when a part may “include” a certain constituent element, unless specified otherwise, it may not be construed that the part does not include another constituent element but may be construed that the part further includes other constituent elements.

In the present specification, an “object” may be a living thing or a non-living thing displayed on an image. Also, the object may be a part of a human and may include organs such as the liver, the heart, the womb, the brain, a breast, the abdomen, etc., or a fetus. Also, the object may include any one section of a human body.

Also, in the present specification, a “user” may be a medical expert including a medical doctor, a nurse, a clinical pathologist, a sonographer, or a medical imaging expert, but the present invention is not limited thereto.

The terms used in the present specification are merely used to describe exemplary embodiments, and are not intended to limit the present invention. An expression used in the singular encompasses the expression of the plural, unless it has a clearly different meaning in the context.

Unless defined otherwise, all terms used herein including technical or scientific terms have the same meanings as those generally understood by those of ordinary skill in the art to which the present inventive concept may pertain. The terms as those defined in generally used dictionaries are construed to have meanings matching that in the context of related technology and, unless clearly defined otherwise, are not construed to be ideally or excessively formal.

In the following description, exemplary embodiments of the present inventive concept are described below in detail with reference to the accompanying drawings.

When providing a three-dimensional (3D) ultrasound image of an object, a conventional medical image display apparatus displays a 3D medical image that is generated by rendering the entire volume data acquired with respect to the object. Accordingly, since a user of a conventional medical image display apparatus is provided with only a 3D medical image of the entire region of the object acquired from the volume data, it is difficult to observe in detail an accurate portion of the object desired by the user.

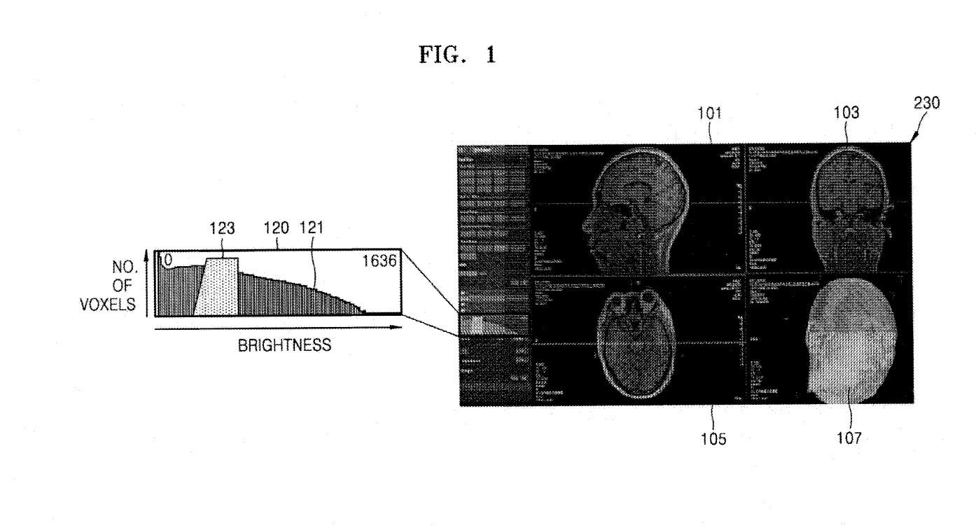

As illustrated in FIG. 1, a technology to generate and display a 3D image of a partial region of the entire region of the object of which volume data is acquired has been developed. The term “volume data” signifies data formed of a plurality of voxels. The volume data of an object may include information about space of the object, and clinical information such as an anatomic shape of a tissue or organ included in the object. For example, the volume data of an object may be data acquired from a signal obtained by irradiating a predetermined signal toward the object and receiving a signal reflected from or passing through the object.

According to the technology illustrated in FIG. 1, the medical image display apparatus may select regions including voxels having brightness values within a predetermined range from the entire region of the object of which volume data is acquired. The medical image display apparatus may generate and display a 3D medical image by rendering only the selected regions.

First, the medical image display apparatus may display two-directional (2D) medical images 101, 103, and 105 showing sections of an object, for example, a patient's head, imaged from different vantage points, e.g., side, back and top views, respectively. From just these 2D sections, a user may have difficulty determining a 3D shape of a tissue or organ included in the object.

To address this problem, the medical image display apparatus may provide a user interface 120 to generate a 3D image of a partial region of the entire region of the object of which volume data is acquired, in which the user shows interest. The user interface 120 of FIG. 1 may include a histogram 121 showing a distribution of the brightness values of the voxels included in the volume data. In the histogram 121, the horizontal axis may indicate a brightness value, while the vertical axis may indicate a value related to the number of voxels having each brightness value in the volume data.

The medical image display apparatus may receive a user input to set a transfer function on the histogram 121 in order to select regions including brightness values included in a predetermined range from the entire region of the object of which volume data is acquired. The setting of a transfer function on the histogram 121 signifies setting a range of brightness values for filtering the volume data so that the medical image display apparatus filters voxels other than the voxels having brightness values included in a predetermined range.

The user may adjust the size and position of a box 123 displayed on the histogram 121. The medical image display apparatus may set a transfer function based on a user input to adjust the box 123. A 3D medical image may be generated and displayed by rendering only regions in the volume data including voxels having brightness values within a range corresponding to the size and position of the box 123.

According to the user interface of FIG. 1, the histogram 121 provides only information about the distribution of voxels included in the volume data of voxels, but not information about the shape or position of a particular unit, for example, a tissue, an organ, etc., of the object. (The numbers 0 and 1636 denote end points of an example range of brightness values.) Accordingly, to display a 3D image of a region of interest (ROI) in which the user shows interest, the user may know in advance the brightness values of voxels included in the ROI. The user may adjust the box 123 such that the box 123 on the histogram 121 has a position and size corresponding to the brightness values of voxels included in the ROI. As the box 123 is adjusted, display properties of a 3D image 107 of the object may change.

When the user does not know in advance the brightness values of voxels included in the ROI, the user may repeat a process of adjusting the size and position of the box 123 and checking a 3D image 107 generated based on the adjusted box 123. The user may determine the size and position of the box 123 most suitable for optimally displaying a 3D image of the ROI by repeating the process of adjusting the size and position of the box 123. However, according to the technology illustrated in FIG. 1, the user may have difficulty setting a transfer function on the histogram 121 intuitively to optimally display a 3D image of the ROI.

Further, according to the technology illustrated in FIG. 1, when the user sets a transfer function on the histogram 121, the medical image display apparatus generates a 3D medical image by rendering all regions including voxels having brightness values corresponding to the transfer function in the entire region of the object, of which volume data is acquired.

The regions including voxels having brightness values corresponding to a transfer function may include a region in which the user has no interest. In other words, a region may be rendered which includes voxels having brightness values corresponding to a set transfer function, even though the user is uninterested in the region. Accordingly, with the UI of FIG. 1, the 3D medical image 107 may include an image of the region in which the user has no interest.

To address the above problems in the technology of FIG. 1, the present inventive concept provides a method and apparatus for quickly and accurately generating and displaying a 3D medical image of a particular portion of an object desired by a user.

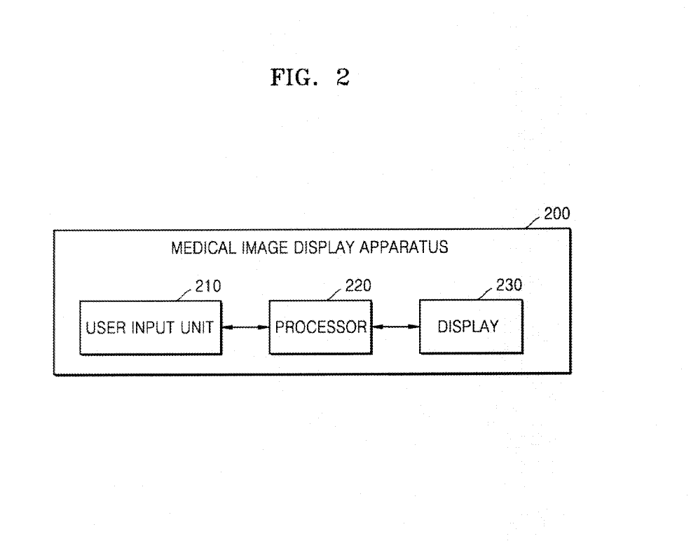

FIG. 2 is a block diagram of a medical image display apparatus 200 according to one of various exemplary embodiments. The medical image display apparatus 200 is configured to display a medical image to a user by using image data stored internally or received from an exterior source. For example, apparatus 200 may display an ultrasound image, an X-ray image, a computerized tomography (CT) image, a magnetic resonance (MR) image, a positron emission tomography (PET) image, etc. and may be used for diagnosis and treatment of diseases.

The medical image display apparatus may be an apparatus fixed at a predetermined unit or a portable apparatus of a cart type or a movable type. The medical image display apparatus may be manufactured only for diagnosis or treatment of diseases, but the present inventive concept is not limited thereto, and may include various devices capable of displaying an image, for example, smart phones, laptop computers, personal digital assistants (PDAs), tablet PCs, etc.

Medical image display apparatus 200 of FIG. 2 may minimally include a user input unit 210, a processor 220, and a display 230.The user input unit 210 is a device for receiving an input of data to control the medical image display apparatus 200. The user input unit 210 may receive a user input to select at least one position in a 2D medical image generated from volume data representing an object. The user input unit 210 may include a hardware configuration such as a keypad, a touch panel, a touch screen, a trackball, a jog switch, etc., but the present inventive concept is not limited thereto and the user input unit 210 may further include various input device such as a sound recognition sensor, a gesture recognition sensor, a depth sensor, a distance sensor, etc.

As an example, the user input unit 210 may include a mouse or a trackball and may receive a user input to select at least one position in a 2D medical image by using a cursor moved according to user's manipulation of a mouse or trackball. The medical image display apparatus 200 may display a 2D medical image showing the object, and select at least one position in the 2D medical image based on a position of cursor moving on the display 2D medical image.

In another example, the user input unit 210 may include a touch screen and recognize a touch by a user selecting a predetermined position on the touch screen. Apparatus 200 may display a 2D medical image showing the object, and select at least one position in the 2D medical image based on a user's touch to select the at least one position in the displayed 2D medical image.

The processor 220 may control an overall operation of the medical image display apparatus 200. The processor 220 may control the user input unit 210 and the display 230.

The processor 220 may determine a space region in the volume data including the position selected by the user, based on the brightness of voxels included in the volume data. For instance, if a point of a 2D image selected by the user is surrounded by or adjacent on at least one side to similar tissue (expressed with similar brightness) of a relatively small volume, then a local space region corresponding to this small volume region may be determined. This small volume region may be subsequently displayed by itself as a 3D medical image. If the selected point is surrounded by similar tissue of a higher volume, the local space region may be determined and subsequently displayed as a 3D medical image corresponding to the higher volume of tissue.

The processor 220 may obtain a brightness value of the position selected by the user. Also, the processor 220 may obtain coordinate information indicating a location of at least one position selected in the volume data based on the user input.

The processor 220 may use various region dividing algorithms to determine the space region in the volume data including the position selected by the user. For example, the processor 220 may use a threshold value method, an edge detection method, a method of using a particular value of texture, a region growing algorithm, an active contour algorithm, etc., as the region dividing algorithm.

According to a threshold value method, which is an image dividing method using a threshold value, a histogram is generated for a given image and a region of interest (ROI) is separated by determining a threshold value. In the edge detection method, a pixel having discontinuous gray level is sought in an image. In the region growing algorithm, a region is extended and divided by measuring a degree of similarity between pixels. The method using a particular value of texture is a method of quantifying a discontinuous change of a pixel value in an image and may be classified into a statistics method and a structural method. In the active contour algorithm, contour information is generated by a vector field that minimizes a defined energy function and a contour line is detected through generated contour information. The above-described image dividing methods/algorithms are well-known technologies, thus detailed descriptions thereof are omitted.

In an example, the processor 220 may obtain a brightness value of the position selected by the user in a 2D image. The processor 220 may determine brightness values included in a predetermined range of the brightness value including the obtained brightness value. The predetermined range may be a predetermined brightness value range or a brightness value range set by the user. The processor 220 may determine the space region in the volume data including the selected position and formed of voxels having the determined brightness values. The processor 220 may determine the space region in the volume data by using the region growing algorithm, by extending a region from the position selected by the user.

In another example, when the user input to select at least one position in a 2D medical image representing a section of the object, the processor 220 may set an initial region in the volume data including the position selected by the user. For example, the initial area may have a spherical shape having a predetermined size. The processor 220 may determine a contour of a tissue of the object included in the set initial region. The tissue of the object included in the set initial region may be a particular portion or sub-object (e.g., organ, tumor, etc.) in which the user may show interest. The processor 220 may determine a contour of the tissue included in the initial region by using the active contour algorithm. The processor 220 may determine a space region in the volume data based on a determined contour. The processor 220 may determine a region included in the determined contour as a space region that the user desires to see in 3D.

Alternatively, the processor 220 may automatically set a transfer function based on the brightness values of pixels included in an ROI set on a 2D medical image with respect to the object.

For example, consider a case in which a user receives 3D images respectively representing gray matter, white matter, and the spinal fluid from a T1 image of a brain. In this case, the user may set an ROI corresponding to one of the gray matter, the white matter, and the spinal fluid on the T1 image of the brain. The processor 220 may automatically define a transfer function based on the brightness values of pixels included in the set ROI. The processor 220 may filter out voxels other than the voxels having brightness values of the pixels included in the set ROI. The processor 220 may determine a space region including the voxels having brightness values corresponding to the brightness values of the pixels included in the set ROI, as a space region that the user desires to see in 3D.

The processor 220 may generate a 2D medical image from the volume data. Also, the processor 220 may generate a 3D medical image representing a spatial region including the position selected by the user, by filtering the volume data.

The display 230 displays a medical image generated by the medical image display apparatus 200. The display 230 may display both a 2D medical image and a 3D medical image generated by the processor 220. Also, the display 230 may display not only the medical image generated by the medical image display apparatus 200 but also various items of information processed by the medical image display apparatus 200, through a graphic user interface (GUI).

The display 230 may include at least one of a liquid crystal display, a thin film transistor-liquid crystal display, an organic light-emitting diode, a flexible display, a 3D display, and an electrophoretic display.

The display 230 may display a 3D medical image representing a partial region in the volume data including the position selected by the user.

The display 230 may display a marker indicating a location of the position selected by the user in the space region determined in the volume data, on a 3D medical image. Also, the display 230 may display a 3D image to be at least partially overlapped with a 2D image, or displayed side by side a 2D image.

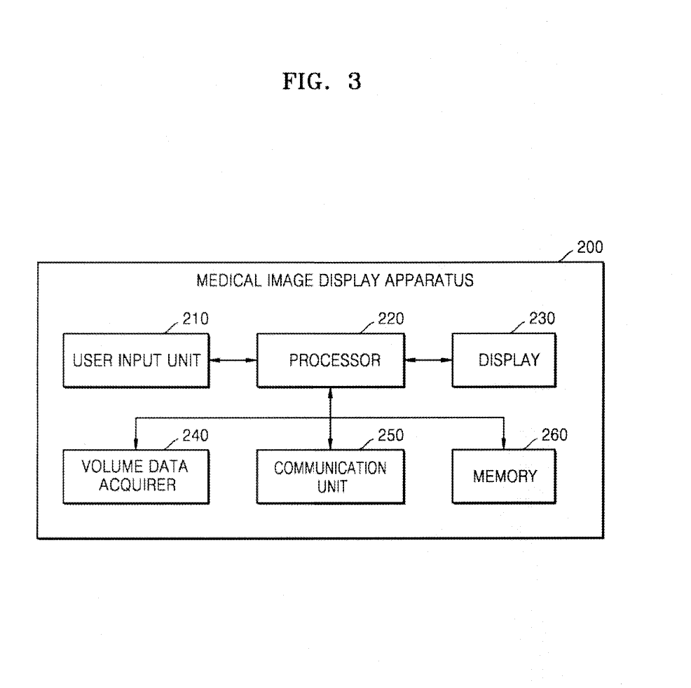

Also, as illustrated in FIG. 3, the medical image display apparatus 200 according to one of various exemplary embodiments may further include at least one of a volume data acquirer 240, a communication unit 250, and a memory 260.

The volume data acquirer 240 may acquire volume data of an object. In an example, the volume data acquirer 240 may form volume data of an object by using a signal obtained by irradiating a predetermined signal toward the object and receiving a signal reflected from the object or having passed through the object. In another example, the volume data acquirer 240 may acquire volume data through the communication unit 250 from an external source. In another example, the volume data acquirer 240 may acquire volume data previously stored in the memory 250.

The volume data acquirer 240 may generate volume data of a 3D space region of the object by combining a plurality of images of a plurality of sections of the object. The communication unit 250 is connected to a network in a wired or wireless manner to communicate with an external device or server. The communication unit 250 may exchange data with a hospital server or other medical apparatuses in a hospital via the picture archiving and communication system (PACS). Communication unit 250 may perform data communication according to the digital imaging and communications in medicine (DICOM) standard.

The communication unit 250 may transceive data related to diagnosis of the object, for example, ultrasound image, ultrasound image data, Doppler image data of the object 20, or a medical image imaged by other medical apparatus such as CT, MRI, X-ray, etc., via the network. Furthermore, the communication unit 250 may receive information such as a diagnosis history or treatment schedule of a patient from the server and use for diagnosis of the object. Furthermore, the communication unit 250 may perform data communication not only with the server or medical apparatuses in a hospital, but also with a portable terminal of a doctor or patient.

The communication unit 250 may include at least one element that enables communication with an external device or server, for example, a short range communication module, a wired communication module, and a mobile communication module.

A short range communication module refers to a module for short range communication within a predetermined distance. Short-range communication technology may include wireless LAN, Wi-Fi, Bluetooth, ZigBee, Wi-Fi direct (WFD), ultra-wideband (UWB), infrared data association (IrDA), Bluetooth low energy (BLE), near field communication (NFC), etc., but the present exemplary embodiment is not limited thereto.

A wired communication module refers to a module for communication using an electric signal or optical signal. Wired communication technology according to an exemplary embodiment may include a pair cable, a coaxial cable, a fiber optic cable, an Ethernet cable, etc.

A mobile communication module transceives a wireless signal with at least one of a base station, an external device, and a server on a mobile communication network. The wireless signal may include a voice call signal, a video call signal, or various types of data according to text/multimedia message transceiving.

The memory 260 stores various items of information processed by the medical image display apparatus 200. For example, the memory 260 may store medical data related to diagnosis of an object, such as, medical image data input to the medical image display apparatus 200 or a medical image provided through the medical image display apparatus 200. Also, the memory 260 may store an algorithm or program performed in the medical image display apparatus 200.

The memory 260 may be embodied by various types of storage media such as flash memory, hard disk, EEPROM, etc. Memory 260 may run a web storage or a cloud server that performs a storage function of the memory 260 on the web.

The processor 220 may control not only the overall operations of the user input unit 210 and the display 230 but also the overall operations of the volume data acquirer 240, the communication unit 250, and the memory 260.

Some or all or the processor 220, the volume data acquirer 240, and the memory 260 may be operated by a software module, but in other embodiments, some of the above-described structure may be operated by hardware. Also, at least a part of the volume data acquirer 240 and the memory 260 may be included in the processor 220, but in other embodiments they may be separate from processor 220.

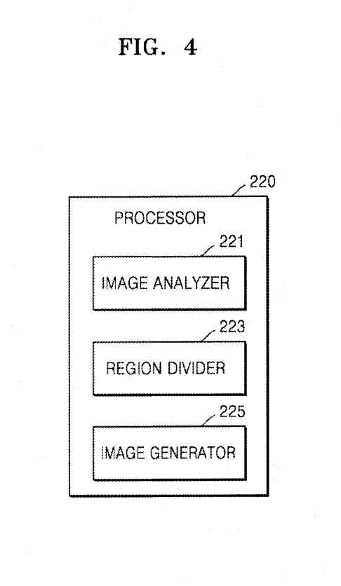

FIG. 4 is a block diagram of an example processor 220 included in the medical image display apparatus 200 according to one of various exemplary embodiments. Processor 220 may include an image analyzer 221, a region divider 223, and an image generator 225.

The image analyzer 221 may analyze a 2D medical image and/or a 3D image generated from the volume data representing the object. Image analyzer 221 may analyze brightness of voxels included in the volume data.

When the 2D medical image showing the object is displayed and a user input to select at least one position in the displayed 2D medical image is received, the image analyzer 221 may acquire a brightness value of the position selected by the user.

The region divider 223 may divide volume data into a plurality of space regions based on the brightness of voxels included in the volume data. The region divider 223 may determine a space region in the volume data including the position selected by the user and divide the volume data into a local space region associated with the selected position, and other space regions. For instance, if a certain point of a 2D image selected by the user is surrounded by similar tissue (expressed with similar brightness) of a small volume, then the region divider may determine the local space region corresponding to this small volume region. This small volume region may be subsequently displayed as a 3D medical image. If the selected point is surrounded by similar tissue of a higher volume, the local space region may be determined and subsequently displayed as a 3D medical image corresponding to the higher volume of tissue.

The region divider 223 may use various region dividing algorithms to determine the local space region in the volume data including the position selected by the user.

The image generator 225 may generate a medical image by using the volume data representing the object. The image generator 225 may generate a 3D ultrasound image through a volume rendering process with respect to the volume data. Furthermore, the image generator 225 may display various items of additional information on the medical image by using text or graphics. For example, a marker indicating a location of the position selected by the user in the volume data may be displayed on the 2D and/or 3D medical image.

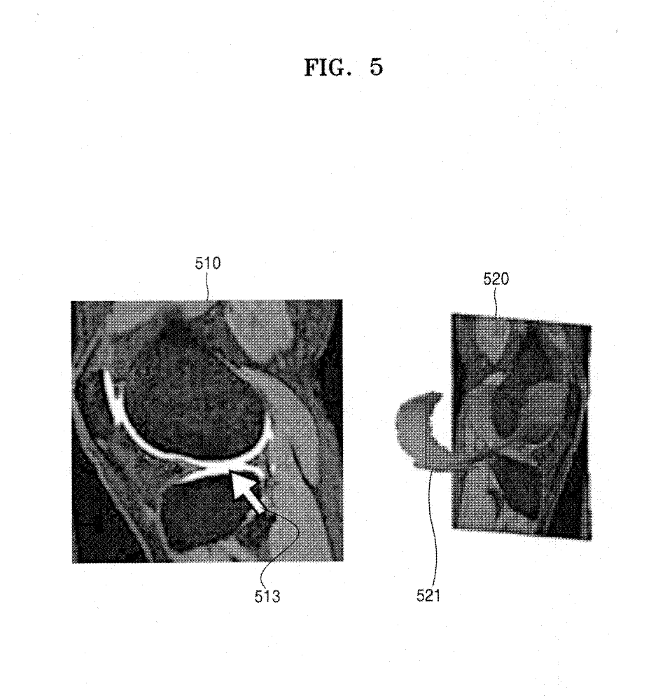

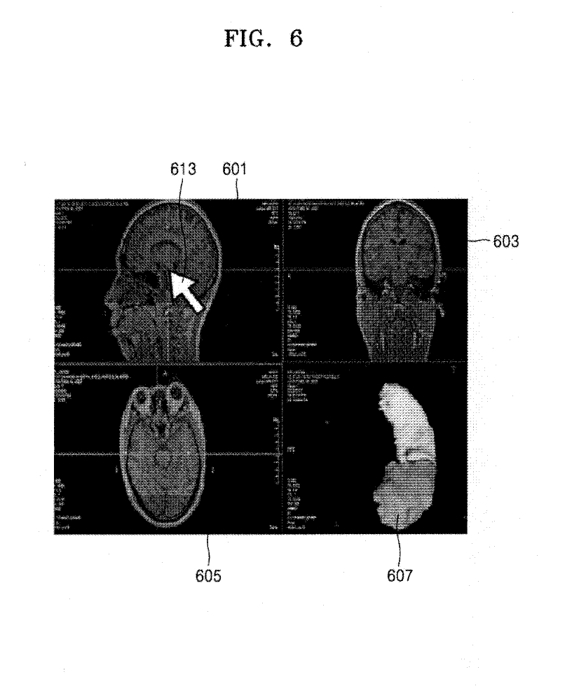

FIGS. 5 and 6 are example screen images of a 3D medical image displayed by the medical image display apparatus 200 according to an exemplary embodiment. FIG. 5 illustrates a case in which the medical image display apparatus 200 (interchangeably, just “apparatus 200” for brevity) displays images of a patient's knee. First, apparatus 200 may generate and display a 2D medical image 510 on display 230 showing a section of a knee. With just the 2D image 510, a user may have difficulty visualizing the space characteristics of an object or information about an anatomic shape of a tissue included in the object. For example, if the user were to observe a 3D shape of knee cartilage of a patient, the user may have a better grasp of a proper diagnosis.

Apparatus 200 may receive a user input to select a position in the 2D medical image 510. The user may select a position included in the patient's knee cartilage by using a cursor 513 movable on the 2D medical image 510 according to the manipulation of the user.

Apparatus 200 may determine a space region in the volume data including the position selected by the user, based on the brightness of voxels included in the volume data. As illustrated in FIG. 5, apparatus 200 may determine a space region corresponding to the patient's knee cartilage and generate and display a 3D medical image 521 on display 230 showing the determined space region. Apparatus 200 may display the 3D medical image 521 at least partially overlapped with a 2D medical image 520.

FIG. 6 illustrates a case in which the medical image display apparatus 200 displays images of a patient's head.

First, apparatus 200 may generate and display 2D medical images 601, 603, and 605 showing sections of a head. For example, a T1 image of a brain may be generated and displayed. Images of the head along a coronal plane, a sagittal plane, and an axial plane may be displayed.

However, a sectional image does not allow one to easily and accurately recognize information about a 3D shape of a particular portion of a brain, for example, hypophysis, basal ganglia, hippocampus, etc. For example, a user may want to observe a 3D shape of hippocampus of a patient.

Apparatus 200 may receive a user input to select a position in a 2D medical image 601. The user may select a position included in the hippocampus of a patient, by using a cursor 613 moving on a 2D medical image 601 according to the manipulation of the user.

Responsive to the hippocampus selection, apparatus 200 may determine a space region in the volume data including the position selected by the user, based on the brightness of voxels included in the volume data. As illustrated in FIG. 6, the medical image display apparatus 200 may determine a space region corresponding to the hippocampus of a patient and generate and display a 3D medical image 607 showing a determined space region.

Moreover, apparatus 200 may provide not only information about a 3D shape of a particular portion of a brain but also information about a 3D shape of a region having a distribution of brightness values different from a surrounding tissue like a tumor. A tumor has a relatively bright characteristic compared to a surrounding tissue in a brain image. Accordingly, apparatus 200 may generate and display a 3D image showing a 3D shape of a brain tumor, based on a user input to select at least one position included in the region representing a tumor in a 2D brain image.

A user of apparatus 200 may quickly and accurately receive a 3D image of an ROI while viewing a sectional image of the object. Accordingly, apparatus 200 may facilitate analysis of an image by a user and further improve accuracy in diagnosis of diseases, by providing information about a 3D shape of a local portion of an object that is not provided from a 2D sectional image.

In another condition, when a user selects at least one position from a 2D medical image, it may be difficult for the user to recognize a location of the selected position in a 3D medical image showing a space region of the object. Accordingly, apparatus 200 may improve user convenience by displaying a marker representing a location of the position selected by the user on a 3D medical image.

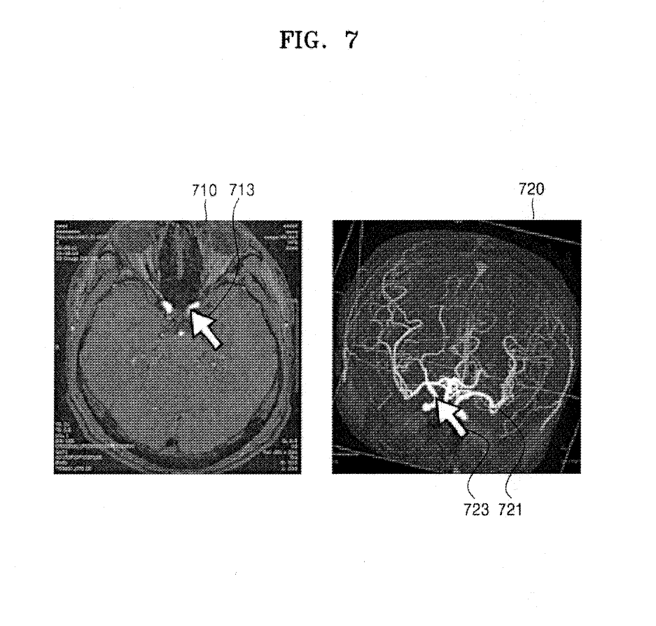

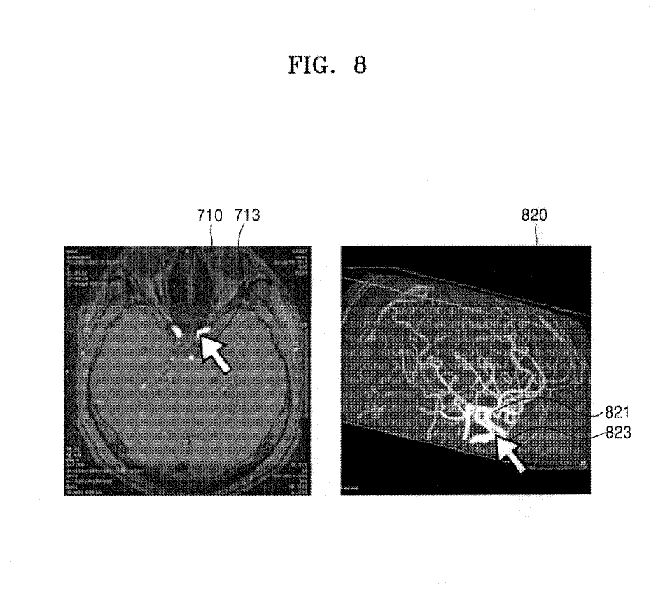

FIGS. 7 and 8 show respective screen images of a 3D medical image on which a marker indicating a location of a selected position in a two dimensional medical image is displayed, when a medical image display apparatus according to an exemplary embodiment displays the 3D medical image.

FIGS. 7 and 8 illustrate a case in which the medical image display apparatus 200 displays images of a patient's brain. First, apparatus 200 may generate and display a 2D medical image 710 representing a section of a head. For example, the medical image display apparatus 200 may generate and display a time-of-flight (TOF) image of a head.

A user may be unable to acquire accurate spatial information of an object or information about an anatomic shape of a tissue in the object from just the 2D medical image 710. For example, the user may need to observe a 3D shape of blood vessels of a patient's brain.

Apparatus 200 may receive a user input to select a position in the 2D medical image 710. The user may select a position included in a region representing blood vessels of a patient by manipulating a cursor 713 moving on the 2D medical image 710 and selecting a point at the cursor tip using a mouse or the like.

Apparatus 200 may determine a space region in the volume data including the position selected by the user, based on the brightness of voxels included in the volume data. As illustrated in FIG. 7, apparatus 200 may determine a space region corresponding to the blood vessels of a patient's brain, and generate and display a 3D medical image 720 showing blood vessels by applying the maximum intensity projection (MIP) rendering to volume data. Apparatus 200 may generate and display the 3D medical image 720 in which a blood vessel region 721 including the position selected by the user is emphasized. A marker 723 may be displayed, which indicates a location of the position selected by the user in the blood vessel region 721 on the 3D medical image 720.

Apparatus 200 may rotate the 3D medical image 720 according to user input. When the 3D medical image 720 is rotated, a 3D medical image 820, as illustrated in FIG. 8, may be displayed, in which a view point is changed. The 3D medical image 820 with a changed view point is an image with a blood vessel region 821 including the position selected by the user.

The change of the view point of a 3D medical image may signify a change of a direction in which volume data is rendered. Even when the view point of the 3D medical image is changed, apparatus 200 may display a marker 823 indicating a location of the position selected by the user, on the rotated 3D medical image 820.

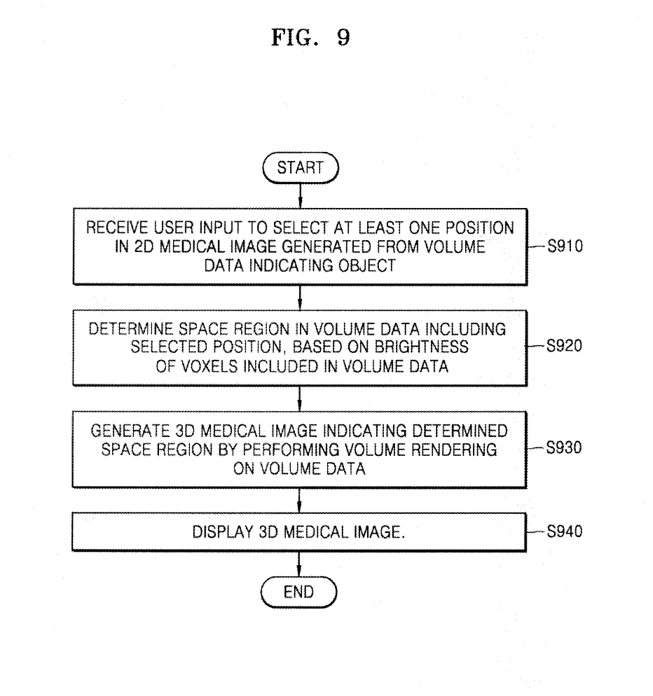

FIG. 9 is a flowchart of a method of displaying a 3D medical image, the method being performed by a medical image display apparatus, according to one of various exemplary embodiments.

Each of the operations of the method of FIG. 9 may be performed by the elements of the medical image display apparatus 200 illustrated in FIG. 2 or 3.Redundant description with respect to FIG. 2 or 3 is omitted for brevity. In particular, each of the operations may be considered controlled by processor 220.

In S910, apparatus 200 may receive a user input to select at least one position in the 2D medical image generated from the volume data representing the object. Apparatus 200 may display a 2D medical image and receive a user input to select at least one position in the displayed 2D medical image. For example, apparatus 200 may obtain coordinate information representing a location of the at least one position in the volume data, based on the user input.

In S920, apparatus 200 may determine a space region in the volume data including the position selected in the operation S910, based on the brightness of voxels included in the volume data. Apparatus 200 may use various region dividing algorithms to determine the space region in the volume data including the selected position. Also, apparatus 200 may determine the space region in the volume data including the selected position further considering the coordinate information with respect to the selected position, and the similarity in brightness of tissue surrounding the selected position to the brightness at the selected position.

In S930, apparatus 200 may generate a 3D medical image representing the space region determined in the operation S920, by performing volume rendering on the volume data. In S940, display apparatus 200 may display a 3D medical image. Apparatus 200 may display on the 3D medical image a marker representing a location of the position selected in the operation S910 in the space region determined in the operation S920. Further, apparatus 200 may display the 3D medical image at least partially overlapped with the 2D medical image.

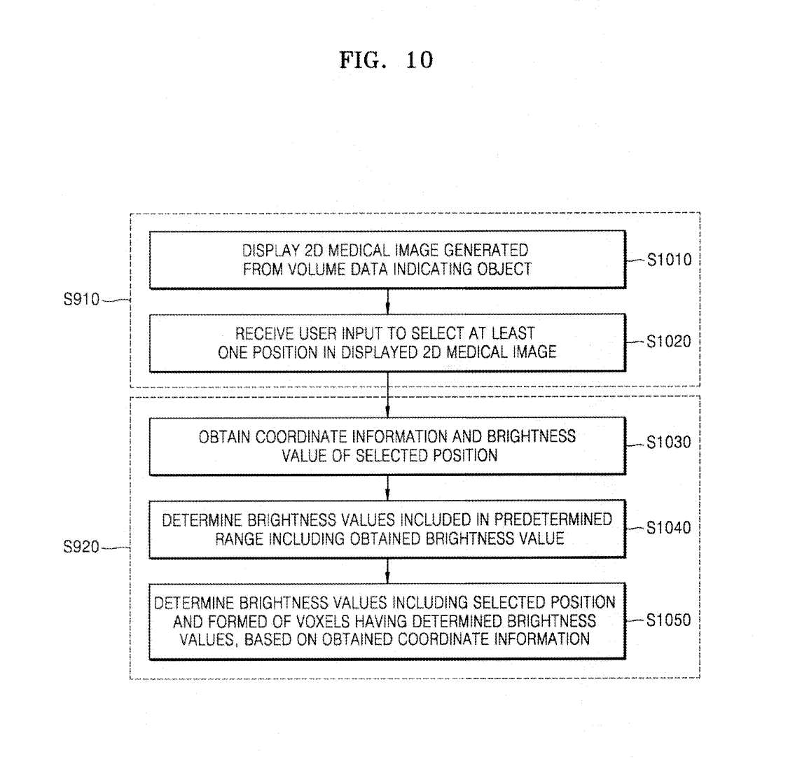

FIG. 10 is a flowchart of a method of determining a space region in volume data including a position selected by a user, the method being performed by the medical image display apparatus 200, according to one of various exemplary embodiments.

When a user input for selecting at least one position in a 2D medical image is received, apparatus 200 may display a 2D medical image generated from the volume data representing the object (S1010) and receive the user input to select at least one position in the displayed 2D medical image (S1020).

Moreover, apparatus 200 may obtain coordinate information and a brightness value of the position selected by the user (S1030), and determine brightness values included in a predetermined range including the obtained brightness value (S1040). Apparatus 200 may determine a space region in the volume data including the position selected by the user and formed of voxels having the determined brightness values, based on the obtained coordinate information (S1050).

An embodiment of the present invention may be embodied in the form of a non-transitory recording medium including computer executable command languages such as a program module executed by a computer. A computer-readable storage medium may be a useable medium that may be accessed by a computer and may include all of volatile and non-volatile media or a separable and inseparable media. Also, the computer-readable storage medium may include all of a computer storage medium and a communication medium. The computer-readable storage medium may include all of volatile and non-volatile media or a separable and inseparable media embodied by a certain method or technology for storing information such as computer-readable command languages, data structures, program modules, or other data. The communication medium may typically store code of computer-readable command languages, data structures, program modules, or other data of a modulated data signal, or other transmission mechanism, and may also include a certain information forwarding medium

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method for displaying a medical image of an object, the method comprising:
receiving a user input to select at least one position in a two dimensional (2D) medical image generated from volume data representing the object;
determining a space region in the volume data including the selected position, based on brightness of voxels included in the volume data;
generating a three dimensional (3D) medical image representing the determined space region by performing volume rendering on the volume data; and
displaying the 3D medical image.

2. The method of claim 1, wherein the receiving of the user input comprises:
displaying the 2D medical image; and
receiving a user input to select at least one position in the displayed 2D medical image.

3. The method of claim 1, wherein the receiving of the user input comprises:
displaying the 2D medical image; and
obtaining coordinate information indicating a location of the at least one position in the volume data, based on the user input to select the at least one position in the displayed 2D medical image.

4. The method of claim 1, wherein the determining of the space region in the volume data comprises:
obtaining a brightness value of the selected position;
determining brightness values included in a predetermined range which is based on the obtained brightness value; and
determining the space region as a region formed of voxels having the determined brightness values.

5. The method of claim 1, wherein the space region is determined by using a region growing algorithm.

6. The method of claim 1, wherein determining the space region in the volume data comprises:
setting an initial region having a predetermined size including the selected position;
determining a contour of a tissue of the object included in the set initial region; and
determining the space region in the volume data based on the determined contour.

7. The method of claim 6, wherein the contour is determined using an active contour algorithm.

8. The method of claim 1, further comprising displaying, on the 3D medical image, a marker indicating a location of the selected position in the determined space region.

9. The method of claim 1, wherein the 3D medical image is displayed at least partially overlapping the 2D medical image.

10. A medical image display apparatus comprising:
a user input unit configured to receive a user input to select at least one position in a two dimensional (2D) medical image generated from volume data representing an object;
a processor configured to determine a space region in the volume data including the selected position, based on brightness of voxels included in the volume data, and generate a three dimensional (3D) medical image representing the determined space region by performing volume rendering on the volume data; and
a display configured to display the 3D medical image.

11. The medical image display apparatus of claim 10, wherein the display is further configured to display the 2D medical image, and the user input unit is further configured to receive a user input to select at least one position in the displayed 2D medical image.

12. The medical image display apparatus of claim 10, wherein the display is further configured to display the 2D medical image, the user input unit is further configured to a user input to select at least one position in the displayed 2D medical image, and the processor is further configured to obtain coordinate information indicating a location of the at least one position in the volume data based on the user input.

13. The medical image display apparatus of claim 10, wherein the processor is further configured to obtain a brightness value of the selected position, determines brightness values included in a predetermined range determined based on the obtained brightness value, and determines the space region in the volume data including the selected position and formed of voxels having the determined brightness values.

14. The medical image display apparatus of claim 10, wherein the processor is further configured to determine the space region in the volume data including the selected position by using a region growing algorithm.

15. The medical image display apparatus of claim 10, wherein the processor is further configured to set an initial region having a predetermined size including the selected position, determine a contour of a tissue of the object included in the set initial region, and determine the space region in the volume data based on the determined contour.

16. The medical image display apparatus of claim 15, wherein the processor is further configured to determine the contour of a tissue of the object included in the set initial region by using an active contour algorithm.

17. The medical image display apparatus of claim 10, wherein the display is further configured to display a marker representing a location of the selected position in the determined space region on the 3D medical image.

18. The medical image display apparatus of claim 10, wherein the display is further configured to display the 3D medical image at least partially overlapping the 2D medical image.

19. The medical image display apparatus of claim 10, wherein the processor is further configured to:
detect a user input setting a region of interest (ROI) corresponding to a particular type of matter;
automatically define a transfer function based on brightness values of pixels included in the set ROI; and
determine the space region by filtering out voxels other than voxels having brightness values of pixels included in the set ROI.

20. A non-transitory computer readable storage medium having stored thereon program instructions, which when executed by a computer, causes a medical image display apparatus to:
receive a user input to select at least one position in a 2D medical image generated from volume data representing an object;
determine a space region in the volume data including the selected position, based on brightness of voxels included in the volume data;
generate a 3D medical image representing the determined space region by performing volume rendering on the volume data; and
display the 3D medical image.
